(19) United States
(12) Patent Application Publication
(10) Pub. No.: US 2026/0096542 A1
(43) Pub. Date: Apr. 9, 2026

(54) CHICKEN NEST WITH EGG COLLECTOR

(71) Applicants: Dmitrii Aleksandrovich Chikunov, Moscow (RU); Obschestvo s Ogranichennoy Otvetstvennostyu Chistoye Prechistoye, Istra (RU)

(72) Inventor: Dmitrii Aleksandrovich Chikunov, Moscow (RU)

(21) Appl. No.: 18/868,903

(22) PCT Filed: Jun. 9, 2023
(86) PCT No.: PCT/RU2023/000176

§ 371 Date: Nov. 25, 2024

(51) Int. Cl. A01K 31/16

(52) U.S. Cl. CPC A01K 31/165

(57) ABSTRACT

The system of the present invention relates to poultry farming, specifically modular nesting systems for chicken coops and bird cages. The system includes side walls, a back wall, a floor, a ceiling, a perch, and a movable egg-collecting tray with inclined and horizontal sections. A sloped mesh (5°-25°) guides eggs into the tray, while the tray's inclined floor section (155°-175°) is covered with elastic material to reduce rolling speed and impact force. These features minimize egg damage and improve sanitary conditions during storage, making the system suitable for industrial and small-scale poultry operations.

### TECHNICAL FIELD

Embodiments disclosed herein relate generally to the field of poultry farming, and more specifically to modular nesting systems designed for use in chicken coops and bird cages. These systems are intended to provide improved egg protection and enhanced sanitary conditions during egg collection and storage in industrial and small-scale poultry farming setups.

### BACKGROUND ART

In poultry farming, particularly in the context of industrial and small-scale farming, efficient egg collection and storage systems are crucial for minimizing egg damage and maintaining sanitary conditions. Traditional nesting systems typically consist of enclosures with fixed floors, collecting trays, and minimal mechanisms for reducing the speed and impact of eggs rolling into the collection area. These conventional designs often fail to provide adequate protection for eggs, leading to a significant rate of damage during collection and storage.

One known system involves a cell structure that includes side, front, and back walls, a door, a feeder, a floor, a ceiling, and a collecting tray, where the floor is configured as a conveyor with a slope toward the collecting tray (e.g., Utility Model Patent RU 110226). While this design offers a basic means of egg collection, it does not sufficiently address the risks of egg breakage or contamination from unsanitary conditions. Eggs rolling on hard or improperly inclined surfaces can accumulate damage due to excessive rolling speeds or high fall heights.

Existing solutions also often neglect features that enable modularity or adaptability for different poultry environments, such as small private farms or industrial setups. Furthermore, while some systems incorporate inclined surfaces to facilitate egg collection, the materials and angles used are not always optimized to reduce rolling speeds and impact forces effectively.

Thus, there is a need for a nesting system that minimizes egg damage during collection, enhances the sanitary conditions of storage, and can be readily adapted for use in a variety of farming setups. The present utility model aims to address these shortcomings by providing a modular nesting system with improved structural and material features.

### SUMMARY OF THE EMBODIMENTS

The present invention relates to a nesting system for poultry designed to minimize egg damage and enhance sanitary conditions during egg collection and storage. The system includes side walls, a back wall, a floor, a roof, a perch, and a movable egg-collecting tray. A sloped mesh is incorporated to guide eggs into the egg-collecting tray, ensuring safe and efficient collection.

In one embodiment, the egg-collecting tray includes an inclined floor section with a slope angle of 155° to 175° relative to the horizontal and a horizontal floor section. The inclined floor section is covered with an elastic material to reduce the impact force and rolling speed of eggs. The sloped mesh, with an inclination of 5° to 25° relative to the horizontal, directs eggs toward the tray and prevents damage during rolling.

In another embodiment, the sloped mesh and the perch are configured to enclose the nesting area, preventing contamination of the egg-collecting tray from bird droppings. The tray is designed to be removable and insertable through sliding guides or rails, allowing for easy egg retrieval and cleaning. The sloped mesh may be made of metal or plastic, while the egg-collecting tray can be constructed from materials such as plastic, metal, or wood.

This modular nesting system is suitable for small-scale farms and industrial poultry operations, providing a practical solution for safe egg collection and storage while maintaining hygiene.

The present invention also provides methods for using the nesting system to safely collect and store eggs while maintaining sanitary conditions. The method includes positioning a laying hen on the perch so that its rear is aligned above a sloped mesh. When the hen lays an egg, the sloped mesh, inclined at 5° to 25° relative to the horizontal, directs the egg toward the movable egg-collecting tray.

The egg transitions from the mesh onto an inclined floor section of the tray, which is angled between 155° and 175° relative to the horizontal. The inclined floor section is covered with an elastic material to reduce the egg's rolling speed and absorb the impact force, minimizing the risk of damage. The egg then stabilizes on the horizontal floor section of the tray.

The method further includes removing the egg-collecting tray to retrieve the collected eggs and clean the tray. The system's design ensures that bird droppings pass through the mesh into designated areas, preventing contamination of the eggs in the tray. These methods make the nesting system highly effective for use in small-scale and industrial poultry operations.

Other aspects, embodiments and features of the undershirt and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the device and method shown where illustration is not necessary to allow those of ordinary skill in the art to understand the device and method.

### BRIEF DESCRIPTION OF THE DRAWINGS

The preceding summary, as well as the following detailed description of the disclosed system and method, will be better understood when read in conjunction with the attached drawings. It should be understood, however, that neither the device nor the method is limited to the precise arrangements and instrumentalities shown.

FIG. 1 illustrates the external structure of the modular nesting system, showing the collecting tray in both closed and open positions.

FIG. 2 depicts the internal structure of the nesting system, highlighting the sloped mesh, perch, and movable egg-collecting tray with its inclined and horizontal sections.

### DETAILED DESCRIPTION OF SPECIFIC EMBODIMENTS

The objective of the system of the present invention is to provide a nesting environment for poultry that minimizes egg damage and enhances sanitary conditions for storage.

This objective is achieved by employing a modular nesting system comprising side and back walls, a floor, a roof, a perch, and a movable egg-collecting tray. The system features a sloped mesh with an inclination of 5°-25° toward the collecting tray. The collecting tray includes an inclined floor section with a slope angle of 155°-175° relative to the horizontal and is covered with an elastic material at least on the inclined portion.

The combination of these features allows the system of the present invention to effectively reduce egg damage and improve the sanitary conditions of egg storage.

The movable collecting tray enables eggs to be stored in a closed environment until removal, protecting them from accidental external impacts. The sloped mesh, with its specified inclination, reduces the speed and impact of rolling eggs while guiding them into the tray. This design also minimizes the height from which eggs fall, further decreasing the likelihood of damage.

The inclined floor of the collecting tray works in tandem with its specified slope angle to slow the eggs' rolling speed and reduce their fall height. Covering the inclined floor with elastic material absorbs the impact force and further mitigates the risk of damage. These combined features significantly decrease the rolling speed, fall height, and subsequent impact force, ensuring safer egg collection and storage.

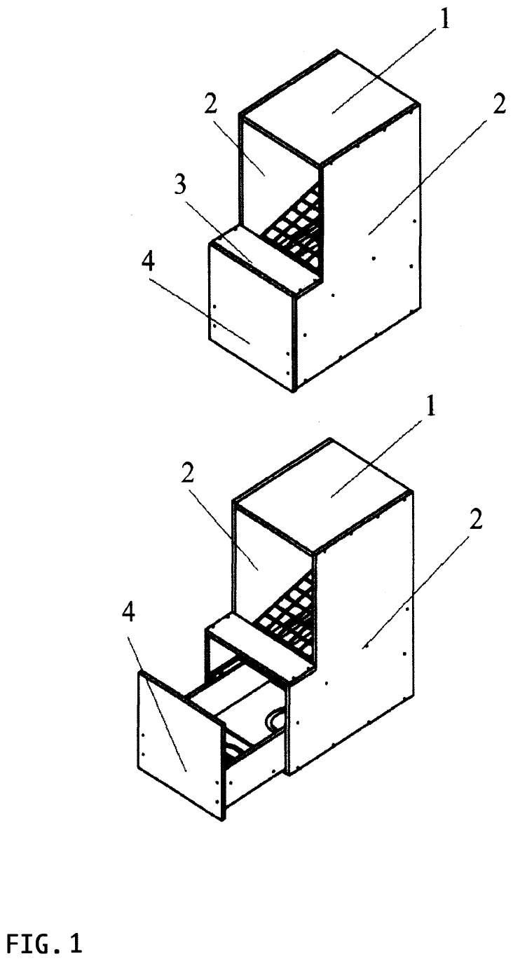

FIG. 1 depicts the system of the present invention with its collecting tray in both closed and open positions. The modular system can be constructed from materials such as wood, plywood, metal, OSB, MDF, or plastics like polystyrene or polypropylene. The frame consists of a roof, side walls, a back wall (not shown), and a floor (not shown). Protruding ledges on the side walls support the movable collecting tray, which can be inserted manually or with auxiliary mechanisms such as sliding guides or rails.

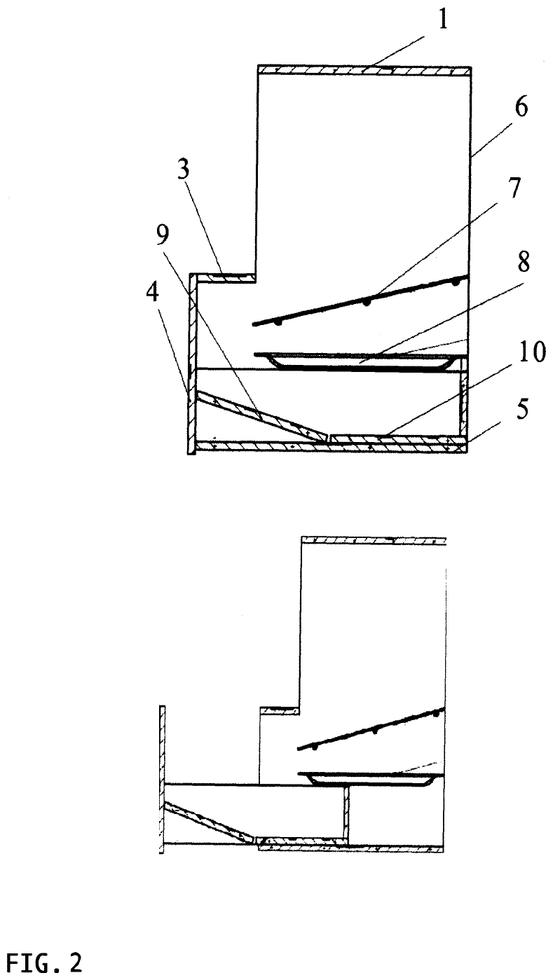

FIG. 2 illustrates the internal structure of the system, showing the sloped mesh, perch, and collecting tray in retracted and extended positions. The sloped mesh (7) is mounted on the side or back walls (6) and is made of metal or plastic to cushion the impact of falling eggs and prevent breakage. The mesh is angled 5°-25° relative to the nest floor (5). Angles below 5° risk eggs remaining on the mesh, while angles above 25° may cause eggs to roll too quickly and break upon entering the tray.

The external structure includes the movable collecting tray (4), consisting of side walls, a back wall, and a floor with inclined (9) and horizontal sections. The perch (8) is installed on the tray's side walls, while the sloped mesh and perch enclose the nesting area, preventing bird droppings from contaminating the collecting tray (4).

The angle of the inclined floor (9) relative to the nest floor (5) is between 155° and 175°. Angles smaller than 155° increase the risk of egg breakage during rolling, while larger angles may cause eggs to remain stationary, resulting in breakage upon impact with subsequent eggs. Covering the inclined floor with elastic materials such as rubber, latex, foam, or fabrics reduces the impact force and rolling speed. The thickness of this material is ideally 1-15 mm to balance shock absorption and smooth egg rolling.

The system is sized to accommodate the specific dimensions of the laying hens using it. During operation, a hen perches on the provided perch (3) with its rear positioned over the sloped mesh (7). When an egg is laid, it falls onto the mesh, rolls gently toward the collecting tray (4), and transitions from the mesh onto the tray's inclined floor (9) before settling on the horizontal surface (10). Waste products fall through the mesh (7) into the perch (8), keeping the eggs uncontaminated. Eggs are collected by removing the tray, at which point the perch can also be cleaned.

The system of the present invention is ideally suited for small household farms and private poultry operations. Its design significantly reduces egg damage while maintaining improved sanitary conditions for egg storage.

The claimed invention provides an innovative solution for poultry nesting systems by addressing the dual challenges of reducing egg damage and improving sanitary conditions for egg storage. This is achieved through a combination of structural features and design optimizations that enhance both functionality and practicality.

The system includes fundamental components such as side walls, a back wall, a floor, a roof, a perch, and a movable egg-collecting tray. The sloped mesh, which is mounted on the side walls or back wall, is a pivotal feature. It guides eggs toward the egg-collecting tray, reducing their rolling speed and minimizing fall heights. The inclination of the mesh, ranging from 5° to 25°, ensures that eggs do not remain stationary or roll too quickly, thereby preventing damage. The mesh, made of durable materials like metal or plastic, also softens the impact of falling eggs to protect them from breaking.

The egg-collecting tray incorporates further advancements to improve egg handling. It includes an inclined floor section with a slope angle of 155° to 175° relative to the horizontal, as well as a horizontal floor section for stabilizing eggs after they roll. The inclined floor section is covered with an elastic material, such as rubber, latex, foam, or synthetic fabrics, to reduce the impact force and rolling speed of eggs. This material's thickness is preferably between 1 mm and 15 mm, providing sufficient shock absorption without impeding egg movement.

For practical use, the egg-collecting tray is designed to be movable and may be inserted or removed using sliding guides or rails. This feature facilitates easy cleaning and retrieval of eggs while ensuring they remain stored in a closed environment, protecting them from accidental external impacts. The perch and sloped mesh enclose the nesting area to prevent contamination of the collecting tray by bird droppings, further enhancing sanitary conditions.

The modular construction of the system allows for adaptation to various poultry farm setups, from small private farms to industrial operations. Materials such as wood, plywood, OSB, MDF, or plastic (e.g., polystyrene or polypropylene) provide flexibility in manufacturing while maintaining durability. The components can be assembled using either permanent or removable joints, offering additional versatility.

The operation of the system demonstrates its effectiveness. A laying hen is positioned on the perch, with its rear part aligned above the sloped mesh. When an egg is laid, it falls onto the mesh and rolls gently toward the egg-collecting tray. The combination of the mesh's inclination and the elastic covering on the tray's inclined floor section ensures that the egg's fall height and speed are minimized, reducing the risk of damage. The egg eventually stabilizes on the horizontal section of the tray, where it can be safely stored until retrieval. The system also ensures that waste products pass through the mesh into a designated area, maintaining cleanliness.

The claimed invention's features are specifically designed to solve the challenges of conventional systems, where eggs are often damaged due to excessive rolling speed, high fall height, or unsanitary conditions. By integrating the sloped mesh and elastic materials into a modular and movable design, the invention significantly reduces egg damage and contamination risks.

Additionally, the claimed methods for using the system further highlight its practical application. The methods include placing a laying hen on the perch, guiding the egg from the mesh to the tray, and cushioning its impact on the elastic material. The tray's removable design simplifies cleaning and egg collection, ensuring the system remains hygienic and efficient.

In summary, the invention provides a comprehensive solution to the challenges of poultry egg collection and storage. Its design ensures that eggs are handled gently and stored hygienically, making it suitable for a wide range of farming operations. By addressing key issues such as egg damage and contamination, the claimed system represents a significant advancement in poultry farming technology.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

The foregoing detailed description is merely exemplary in nature and is not intended to limit the invention or application and uses of the invention. Furthermore, there is no intention to be bound by any expressed or implied theory presented in the preceding technical field, background, brief summary, or the following detailed description.

What is claimed is:

1. A nesting system for poultry, comprising
side walls;
a back wall;
a floor;
a roof;
a perch; and
an egg-collecting tray;
wherein the egg-collecting tray is movable, and the system includes a sloped mesh configured to direct eggs toward the egg-collecting tray.

2. The nesting system of claim 1, wherein the sloped mesh is made of metal or plastic.

3. The nesting system of claim 1, wherein the egg-collecting tray comprises an inclined floor section and a horizontal floor section.

4. The nesting system of claim 1, wherein the sloped mesh has an inclination of 5° to 25° relative to the horizontal.

5. The nesting system of claim 1, wherein the egg-collecting tray is configured to be inserted into the system through sliding guides or rails.

6. A nesting system for poultry, comprising
side walls;
a back wall;
a floor;
a roof;
a perch; and
an egg-collecting tray;
wherein the egg-collecting tray is movable and comprises an inclined floor section with a slope angle of 155° to 175° relative to the horizontal and a horizontal floor section;
wherein the inclined floor section of the egg-collecting tray is covered with an elastic material; and
wherein the system further includes a sloped mesh with an inclination of 5° to 25° relative to the horizontal, the mesh configured to direct eggs toward the egg-collecting tray.

7. The nesting system of claim 6, wherein the inclined floor section of the egg-collecting tray is covered with an elastic material selected from rubber, latex, foam, or synthetic fabrics.

8. The nesting system of claim 6, wherein the elastic material covering the inclined floor section has a thickness of 1 mm to 15 mm.

9. The nesting system of claim 6, wherein the sloped mesh and the perch are configured to prevent bird droppings from entering the egg-collecting tray.

10. The nesting system of claim 6, wherein the egg-collecting tray is removable for cleaning and egg collection.

11. A nesting system for poultry, comprising
side walls;
a back wall;
a floor;
a roof;
a perch; and
an egg-collecting tray;
wherein the egg-collecting tray is movable and comprises:
an inclined floor section with a slope angle of 155° to 175° relative to the horizontal, the inclined floor section covered with an elastic material having a thickness of 1 mm to 15 mm; and
a horizontal floor section;
wherein the system further includes a sloped mesh made of metal or plastic, the mesh having an inclination of 5° to 25° relative to the horizontal;
wherein the sloped mesh and the perch enclose the nesting area to prevent contamination of the egg-collecting tray; and
wherein the egg-collecting tray is configured to be insertable into the system through sliding guides or rails.

12. The nesting system of claim 11, wherein the sloped mesh is mounted on the side walls or back wall of the system.

13. The nesting system of claim 11, wherein the egg-collecting tray is made of materials selected from plastic, metal, or wood.

14. The nesting system of claim 11, wherein the horizontal floor section of the egg-collecting tray is configured to stabilize eggs after rolling down the inclined floor section.

15. The nesting system of claim 11, wherein the perch is positioned to align the laying hen over the sloped mesh for egg collection.

16. A method for using a nesting system for poultry of claim 1, comprising:
positioning a laying hen on the perch;
allowing an egg laid by the hen to fall onto the sloped mesh;
guiding the egg along the sloped mesh toward the egg-collecting tray; and
retrieving the egg by removing the egg-collecting tray.

17. A method for using a nesting system for poultry of claim 6, comprising:
placing a laying hen on the perch so that its rear is positioned above the sloped mesh;
allowing an egg laid by the hen to fall onto the sloped mesh, the mesh directing the egg toward the egg-collecting tray;
guiding the egg onto the inclined floor section of the egg-collecting tray;
reducing the impact force of the egg as it rolls on the elastic material covering the inclined floor section; and
collecting the egg by removing the egg-collecting tray.

18. A method for using a nesting system for poultry of claim 11, comprising:
placing a laying hen on the perch so that its rear is aligned above the sloped mesh;
directing an egg laid by the hen onto the sloped mesh, wherein the mesh has an inclination of 5° to 25° relative to the horizontal;
guiding the egg from the sloped mesh onto the inclined floor section of the egg-collecting tray, the inclined floor section having a slope angle of 155° to 175° relative to the horizontal;
cushioning the impact of the egg with the elastic material covering the inclined floor section;
stabilizing the egg as it rolls onto the horizontal floor section of the tray; and
removing the egg-collecting tray for egg retrieval and cleaning.
